(19) United States
(12) Patent Application Publication
(10) Pub. No.: US 2024/0113376 A1
(43) Pub. Date: Apr. 4, 2024

(54) ELECTRICAL GROUND ASSEMBLY FOR GROUNDING AND FLUIDLY SEALING A VEHICLE COMPONENT

(71) Applicant: Ford Global Technologies, LLC, Dearborn, MI (US)

(72) Inventors: Samuel Jeffrey Tomlinson, Farmington Hills, MI (US); Alexander Robert Rink, Royal Oak, MI (US); Nathaniel Conti, Canton, MI (US)

(73) Assignee: Ford Global Technologies, LLC, Dearborn, MI (US)

(21) Appl. No.: 17/957,348

(22) Filed: Sep. 30, 2022

(51) Int. Cl. H01M 50/262; B60L 50/64; H01M 50/24; H01M 50/249; H01M 50/50

(52) U.S. Cl. CPC H01M 50/262; B60L 50/64; H01M 50/24; H01M 50/249; H01M 50/50; H01M 2200/00; H01M 2220/20

(57) ABSTRACT

A grounding assembly for a battery enclosure includes a washer including a first serrated surface and a second serrated surface opposite the first serrated surface, a fastener including a serrated surface configured to mate with the second serrated surface of the washer, and a seal disposed on the washer. The first serrated surface is configured to remove a non-conductive coating from the battery enclosure. The seal is configured to form a watertight barrier between the washer and the battery enclosure.

### FIELD

The present disclosure relates to electrically grounding a vehicle component.

### BACKGROUND

The statements in this section merely provide background information related to the present disclosure and may not constitute prior art.

Electrical components in vehicles are grounded to inhibit transmission of electricity to other components. An electrical connection is formed between the component and a ground to ground the component. The components often include electrically insulating coatings to inhibit transmission of electricity from contact with the component surface and to inhibit corrosion of the component. Typically, a boss or exposed surface provides the electrical contact for the grounding; however, such a feature can be more susceptible to corrosion.

The present disclosure addresses these challenges related to grounding an electrical component of the vehicle.

### SUMMARY

This section provides a general summary of the disclosure and is not a comprehensive disclosure of its full scope or all of its features.

In one form, a grounding assembly for a battery enclosure includes a washer, a fastener, and a seal. The washer includes a first serrated surface and a second serrated surface opposite the first serrated surface. The fastener including a serrated surface configured to mate with the second serrated surface of the washer. The seal disposed on the washer. The first serrated surface is configured to remove a non-conductive coating from the battery enclosure. The seal is configured to form a watertight barrier between the washer and the battery enclosure.

In variations of the assembly, which may be implemented individually or in combination: the serrated surface of the fastener and the second serrated surface of the washer form an electrical connection to ground the battery enclosure; the fastener is electrically connected to a ground fixture of a battery disposed in the battery enclosure, the ground fixture configured to ground the battery enclosure; the washer defines an opening and the assembly further includes a second seal disposed in the opening; the second serrated surface of the washer includes a plurality of serrations, each serration including a sloped surface and a vertical wall; serrations of the serrated surface of the fastener are configured to engage the vertical walls of the plurality of serrations when the fastener is rotated in a first direction and to move along the sloped surfaces of the plurality of serrations when the fastener is rotated in an opposite direction to the first direction; the plurality of serrations of the second serrated surface of the washer are configured to allow rotation of the washer in a first direction and inhibit rotation of the washer in an opposite direction to the first direction; the fastener is configured to form a friction fit with the battery enclosure; the washer defines a groove and the seal is disposed in the groove; the seal is an elastomer material; the first serrated surface is configured to form an electrical connection with an electrically conductive surface of the battery enclosure upon removal of the non-conductive coating; the electrically conductive surface, the washer, and the fastener form an electrical connection with a ground fixture of a battery disposed in the battery enclosure.

In another form, a vehicle battery assembly includes a battery including a grounding fixture, a battery enclosure including an electrically conductive surface and a non-conductive coating disposed on the surface and defining an opening, and a grounding assembly. The grounding assembly includes a washer including a serrated surface, a fastener configured to rotate the washer, and a seal disposed on the washer. The fastener is fixed to the grounding fixture through the opening of the battery enclosure. The serrated surface is configured to remove the non-conductive coating to form an electrical connection between the electrically conductive surface, the washer, the fastener, and the grounding fixture. The seal is configured to form a watertight barrier between the washer and the battery enclosure.

In variations of the vehicle battery assembly, which may be implemented individually or in combination: the battery enclosure is grounded to the battery via the grounding fixture; the washer further includes a second serrated surface opposite the serrated surface; the second serrated surface is configured to allow rotation of the washer by the fastener in a first direction and inhibit rotation of the washer in an opposite direction to the first direction; the washer defines a groove and the seal is disposed in the groove; the grounding fixture is a stanchion bolt; the fastener forms a friction fit with the grounding fixture; the washer is an elastomer material.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a perspective view of a battery enclosure according to the present disclosure;

FIG. 2 is an exploded view of a grounding assembly of the battery enclosure according to the present disclosure;

FIG. 3 is a perspective view of the grounding assembly according to the present disclosure;

FIG. 4 is a perspective view of a washer of the grounding assembly according to the present disclosure;

FIG. 5 is a perspective view of a fastener of the grounding assembly according to the present disclosure;

FIG. 6 is a perspective view of serrations of the washer and the fastener according to the present disclosure; and

FIG. 7 is a side view of the battery enclosure and the grounding assembly according to the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

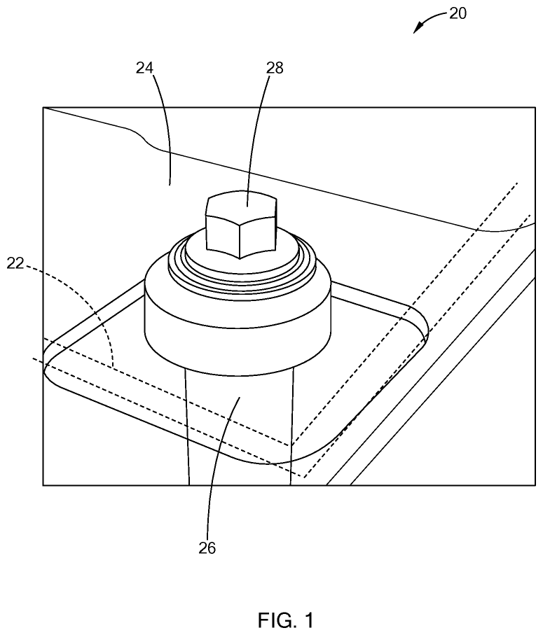

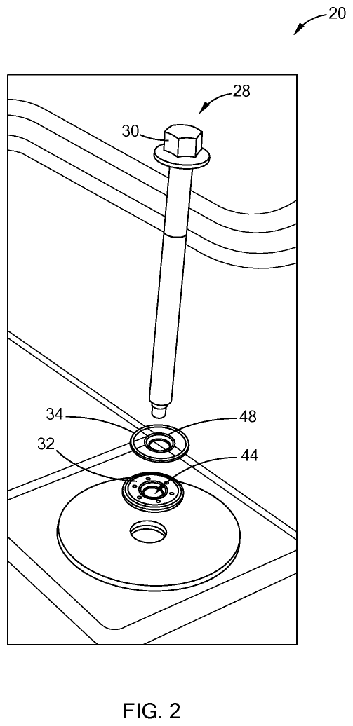

With reference to FIGS. 1-2, in one form, a battery assembly 20 includes a battery 22, a battery enclosure 24 housing the battery 22, and a grounding fixture 26 grounding the battery enclosure 24. The battery 22 provides power to one or more components, such as an electric motor of an electric vehicle. In such a form, the electric motor rotates one or more wheels of the electric vehicle via an axle. In one example, the battery assembly 20 is supported by a vehicle frame, such as between opposed longitudinal rails.

The grounding fixture 26, shown in FIG. 1 as a stanchion bolt, provides an electrical connection to a ground of the battery assembly 20. More particularly, the grounding assembly 28 provides an electrical connection between the battery enclosure 24 and the grounding fixture 26 to ground the battery enclosure 24. Grounding the battery enclosure 24 to the grounding fixture 26 inhibits potential charge buildup on the battery enclosure 24.

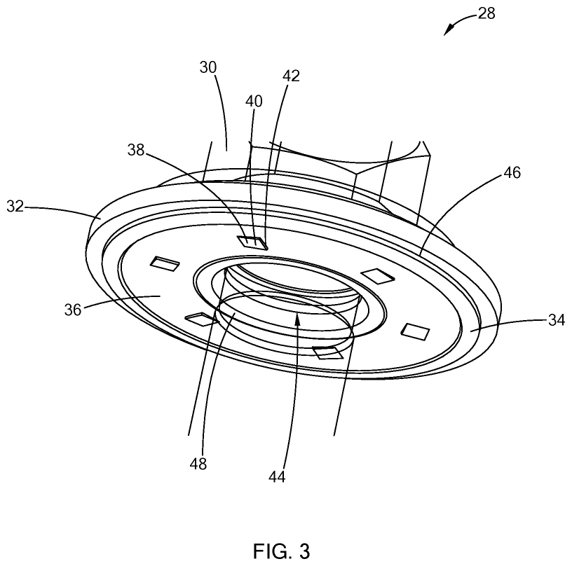

With reference to FIGS. 2-3, in one form, the grounding assembly 28 includes a fastener 30, a washer 32, and a seal 34. The fastener 30 is adapted to have a friction fit with the battery enclosure 24 and with the grounding fixture 26 to fasten the battery enclosure 24 to the grounding fixture 26. In one form, the grounding assembly 28 is configured to electrically connect the battery enclosure 24 and the grounding fixture 26 via the fastener 30 and the washer 32. Specifically, the washer 32 forms an electrical connection between the battery enclosure 24 and the fastener 30, and the fastener 30 forms an electrical connection between the washer 32 and the grounding fixture 26. In one form, the fastener 30 is a bolt disposed through an opening 44 of the washer 32.

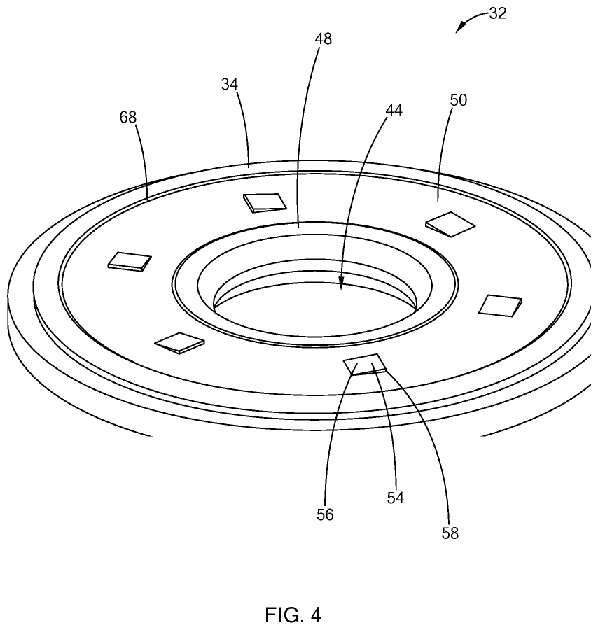

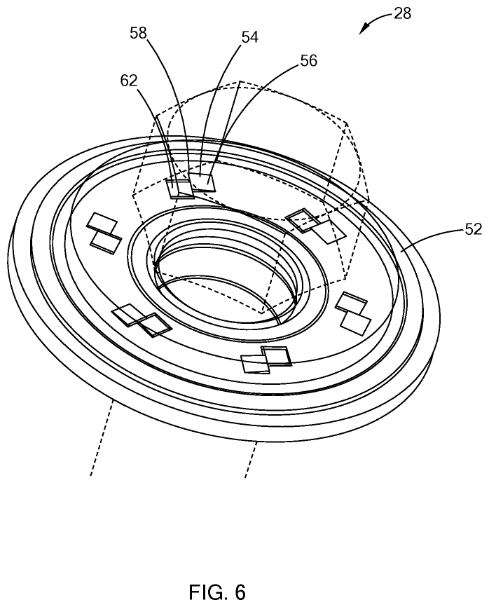

With reference to FIGS. 4-7, in one form, the washer 32 includes a first serrated surface 36 including a plurality of serrations 38 and a second serrated surface 50 opposite the first serrated surface 36. The serrations 38 each include a sloped surface 40 and a vertical wall 42. The second serrated surface 50 includes serrations 54, and similar to the first serrated surface 36, each serration 54 includes a sloped surface 56 and a vertical wall 58. In the form of FIG. 3, the first and second serrated surfaces 36, 50 have identical serrations 38, 54, such that the washer 32 may be installed with either the first serrated surface 36 or the second serrated surface 50 engaging the battery enclosure 24.

In one form, the plurality of serrations 54 of the second serrated surface 50 of the washer 32 are configured to allow rotation of the washer 32 in a first direction and inhibit rotation of the washer 32 in an opposite direction to the first direction. The sloped surfaces 56 of the serrations 54 of the second serrated surface 50 allow force-providing elements, such as the fastener 30, to slide past the serrations 54 in the opposite direction to the first direction. In the form of FIG. 3, the serrations 54 are arranged to allow the washer 32 to rotate in a clockwise direction and to inhibit rotation in a counter-clockwise direction.

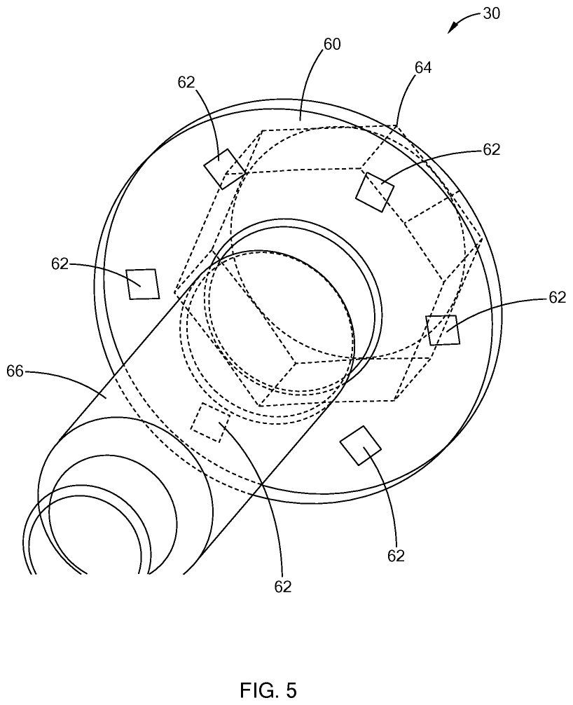

In one form, the fastener 30 includes a head 64 and a shaft 66 as shown in FIG. 4. The head 64 includes a serrated surface 60 including a plurality of serrations 62 extending out therefrom and the shaft 66 fixed to the grounding fixture 26. In one form, the serrations 62 may include respective walls and sloped surfaces, similar to the serrations 54, 62. In another form, the serrations 62 are a different shape, such as rectangular protrusions. The serrated surface 60 of the fastener 30 is configured to mate with the second serrated surface 50 of the washer 32 as shown in FIG. 5. In this context, the serrated surface 60 of the fastener 30 “mates” with the second serrated surface 50 of the washer 32 when the respective serrations 54, 62 of the fastener 30 and the washer 32 contact. When the fastener 30 and the washer 32 mate, an electrical pathway for electric current is formed therebetween. The serrated surface 60 of the fastener 30 and the second serrated surface 50 of the washer 32 thus form the electrical connection to ground the battery enclosure 24 to the grounding fixture 26. In one form, the fastener 30 mates with the washer 32 when the fastener 30 is placed onto the washer 32 such that the serrations 62 of the serrated surface 60 of the fastener 30 mate with the serrations 54 of the second serrated surface 50 of the washer 32. The serrations 62 of the fastener 30 are configured to move along the sloped surfaces 56 of the serrations 54 of the washer 32 and to engage the walls 58 of the serrations 54 of the washer 32.

When the fastener 30 is rotated in the first direction, the serrations 62 of the fastener 30 engage the walls 58 of the serrations 54 of the washer 32, rotating the washer 32 in the first direction. When the fastener 30 is rotated in the opposite direction to the first direction, the serrations 62 of the fastener 30 slide along the sloped surfaces 56 of the serrations 54 of the washer 32, and the washer 32 does not rotate in the opposite direction. Thus, the fastener 30 thus may operate like a ratchet to the washer 32, rotating the washer 32 only in one direction.

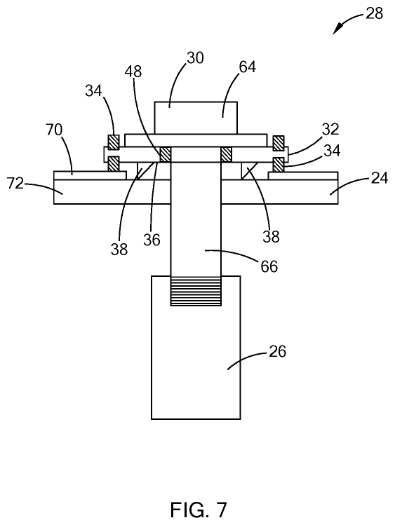

Referring to FIG. 7, in one form, the battery enclosure 24 includes a non-conductive coating 70 disposed atop an electrically conductive surface 72, such as aluminum or steel. The non-conductive coating 70 is a paint or other electrically insulative coating, such as an E-coat material electrodeposited onto the electrically conductive surface 72. The non-conductive coating 70 inhibits electricity from the battery 22 from charging the battery enclosure 24 and shorting to other vehicle components. Generally, the non-conductive coating 70 inhibits an electrical connection that would ground the battery enclosure 24 to the grounding fixture 26, however, as described herein, the grounding assembly 28 defines an electrical pathway/connection for built-up electric energy.

Specifically, in one form, the first serrated surface 36 of the washer 32 removes the non-conductive coating 70 from the battery enclosure 24, directly contacting the electrically conductive surface 72. As described above, rotation of the washer 32 by the fastener 30 causes the serrations 38 on the first serrated surface 36 of the washer 32 to remove the non-conductive coating 70. The walls 42 of the serrations 38 are configured to scrape away the non-conductive coating 70 when the fastener 30 rotates the washer 32. Upon contact between the first serrated surface 36 and the electrically conductive surface 72, the grounding fixture 26 and the electrically conductive surface 72 form an electrical connection that grounds electricity from the battery through the first serrated surface 36 of the washer 32 to the second serrated surface 50 of washer 32 to the serrated surface 60 of the fastener 30 to the shaft 66 of the fastener 30 and to the grounding fixture 26 to which the fastener 30 is fixed.

In one form, the seal 34 is disposed on the washer 32 to form a watertight barrier between the washer 32 and the battery enclosure 24. Specifically, the seal 34 is pressed against the battery enclosure 24 by the washer 32 and the fastener 30 to inhibit ingress of water and other foreign material, such as but not limited to dirt, oil, or other debris. In one form, the seal 34 is an elastomer material that deforms when pressed by the washer 32. In the form of FIG. 2, the washer 32 defines a groove 46 and the seal 34 is disposed in the groove 46. In addition to the seal 34, the washer 32 may include an inner seal 48 disposed in the opening 44, the inner seal 48 forming a watertight barrier between the fastener 30 and the battery enclosure 24 through the opening 44. In addition to the seal 34 and the inner seal 48, the washer 32 includes a second seal 34 disposed in a second groove 68 to inhibit ingress of water and other foreign material. It is understood that the grounding assembly 28 may include some, but not all, of the seal 34, the second seal 34, and/or the inner seal 48, and the number and placement of the seals 34, 48 may be determined based on the expected environment in which the grounding assembly 28 is located.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A grounding assembly for a battery enclosure, the assembly comprising:
a washer including a first serrated surface and a second serrated surface opposite the first serrated surface;
a fastener including a serrated surface configured to mate with the second serrated surface of the washer; and
a seal disposed on the washer;
wherein the first serrated surface is configured to remove a non-conductive coating from the battery enclosure, and
wherein the seal is configured to form a watertight barrier between the washer and the battery enclosure.

2. The assembly of claim 1, wherein the serrated surface of the fastener and the second serrated surface of the washer form an electrical connection to ground the battery enclosure.

3. The assembly of claim 2, wherein the fastener is electrically connected to a ground fixture of a battery disposed in the battery enclosure, the ground fixture configured to ground the battery enclosure.

4. The assembly of claim 1, wherein the washer defines an opening and the assembly further comprises a second seal disposed in the opening.

5. The assembly of claim 1, wherein the second serrated surface of the washer includes a plurality of serrations, each serration including a sloped surface and a vertical wall.

6. The assembly of claim 5, wherein serrations of the serrated surface of the fastener are configured to engage the vertical walls of the plurality of serrations when the fastener is rotated in a first direction and to move along the sloped surfaces of the plurality of serrations when the fastener is rotated in an opposite direction to the first direction.

7. The assembly of claim 5, wherein the plurality of serrations of the second serrated surface of the washer are configured to allow rotation of the washer in a first direction and inhibit rotation of the washer in an opposite direction to the first direction.

8. The assembly of claim 1, wherein the fastener is configured to form a friction fit with the battery enclosure.

9. The assembly of claim 1, wherein the washer defines a groove and the seal is disposed in the groove.

10. The assembly of claim 1, wherein the seal is an elastomer material.

11. The assembly of claim 1, wherein the first serrated surface is configured to form an electrical connection with an electrically conductive surface of the battery enclosure upon removal of the non-conductive coating.

12. The assembly of claim 11, wherein the electrically conductive surface, the washer, and the fastener form an electrical connection with a ground fixture of a battery disposed in the battery enclosure.

13. A vehicle battery assembly, comprising:
a battery including a grounding fixture;
a battery enclosure including an electrically conductive surface and a non-conductive coating disposed on the surface and defining an opening; and
a grounding assembly, comprising:
a washer including a serrated surface;
a fastener configured to rotate the washer; and
a seal disposed on the washer;
wherein the fastener is fixed to the grounding fixture through the opening of the battery enclosure;
wherein the serrated surface is configured to remove the non-conductive coating to form an electrical connection between the electrically conductive surface, the washer, the fastener, and the grounding fixture, and
wherein the seal is configured to form a watertight barrier between the washer and the battery enclosure.

14. The vehicle battery assembly of claim 13, wherein the battery enclosure is grounded to the battery via the grounding fixture.

15. The vehicle battery assembly of claim 13, wherein the washer further includes a second serrated surface opposite the serrated surface.

16. The vehicle battery assembly of claim 15, wherein the second serrated surface is configured to allow rotation of the washer by the fastener in a first direction and inhibit rotation of the washer in an opposite direction to the first direction.

17. The vehicle battery assembly of claim 13, wherein the washer defines a groove and the seal is disposed in the groove.

18. The vehicle battery assembly of claim 13, wherein the grounding fixture is a stanchion bolt.

19. The vehicle battery assembly of claim 13, wherein the fastener forms a friction fit with the grounding fixture.

20. The battery assembly of claim 13, wherein the washer is an elastomer material.
